(19) United States
(12) Patent Application Publication
(10) Pub. No.: US 2017/0027019 A1
(43) Pub. Date: Jan. 26, 2017

(54) HEATER STRUCTURE

(71) Applicant: Protrend Co., Ltd., Taipei City (TW)

(72) Inventor: YU-CHUAN HSIEH, Taipei City (TW)

(21) Appl. No.: 14/854,423

(22) Filed: Sep. 15, 2015

(30) Foreign Application Priority Data
Jul. 24, 2015 (TW) 104124084

(51) Int. Cl. H05B 1/02; H05B 3/00

(52) U.S. Cl. CPC H05B 1/0202; H05B 3/0014

(57) ABSTRACT

A heater structure includes a heating core, at least one heating tube and a temperature switch. The heating core has an inlet, an outlet and an inner space, in which the inlet, the outlet and the inner space can be integrated to form a channel. The heating core has a first lateral wall with a first thickness, and the first lateral wall has an installation portion with a second thickness, in which the first thickness is different to the second thickness. The heating tube providing the thermal energy contacts the heating core. The temperature switch contacting the installation portion is used to detect the temperature.

This application claims the benefit of Taiwan Patent Application Ser. No. 104124084, filed Jul. 24, 2015, the subject matter of which is incorporated herein by reference.

### BACKGROUND OF INVENTION

1. Field of the Invention

The invention relates to a heater structure, and more particularly to a heater structure whose heating core is specially designed at a place locating the temperature switch so as thereby to prevent the heating core from frequently stopping/starting, such that a possible high temperature at the heating core can be avoided.

2. Description of the Prior Art

Generally, heaters inside household appliances can be simply classified into boiler-type heaters and instant electric heaters. No what kind of the heater is, main structures of the heater includes a container for accommodating a liquid medium (heating medium), a heating core located inside the container and a plurality of heating tubes for forming the insides of the heating core.

The boiler-type heater is a static heater that has an internal non-flowing heating medium to be heated as a whole. Namely, during the heating, no new low-temperature medium can be introduced into the container, so that the internal temperature fluctuation can be reduced.

On the other hand, the instant electric heater is a dynamic heater that has an internal flowing heating medium. Namely, during the heating, new low-temperature mediums can be continuously fed into the container and further into the heating core, and the heated mediums can be continuously led out of the heating core and the container. Since the container of the instant electric heater might experience more internal temperature fluctuations or even face a possible transformation in bio-state, thus the temperature switch shall be implemented to detect the temperature of the heating core so as to better control ON/OFF timing of the heating core. Upon such an arrangement, the medium can be heated to a desired temperature, and simultaneously the whole temperature of the heater can be away from overheating and thus being possible burned down. However, since the internal temperature of the instant electric heater may vary severely and rapidly, so the installation location of the temperature switch seems to be significant toward the performance of the appliance with the heater.

To ensure equipment safety of the instant electric heater, the temperature switch shall contact directly the heating core. However, since the temperature switch is usually sensitive to the temperature variations of the heating core, thus in order to effectively conduct the heat of the heating tubes all over to the whole heating core in normal usage, a predetermined structure-dependent distance shall be kept from the installation position of the temperature switch to each of the heating tubes inside the heating core. Nevertheless, following shortcomings still exist.

1. If any of the aforesaid distances is too short, frequent ON/OFF upon the heating core would be met. While the heating core is at a state of off-and-cooling, the fluid-feeding pump would still provide the mediums into the container substantially at the same rate. Since the thermal energy preserved in the heating core is limited, the new-coming medium into the container won't be heated sufficiently by the preserved thermal energy during the off state. Thus, a remarkable internal temperature fluctuation is formed. For example, if the appliance is a steam generator, generation of the steam and the associated temperature would demonstrate a significant drop.

2. Further, the distance between the temperature switch and the individual heating tube would contribute a conduction delay to the temperature rise. Namely, when the temperature switch detects to automatically shut off the heater, the instant high temperature inside the heating core would happen to the heating tubes, the remaining thermal energy at the heating tubes would spread to the whole heating core, and thus a local arbitrary temperature rise would be then met. Occasionally, while the container is at a dry-burn state without additional medium input to control the temperature rise, the metallic heating core would be heated up to an unacceptable temperature. Generally, the more the distance between the temperature switch and the heating tube is, the larger is the temperature rise. The temperature rise is elevated from the switching temperature of the temperature switch to an accumulative high temperature, which might jeopardize the shell material and further threaten the safety usage of the appliance.

### SUMMARY OF THE INVENTION

Accordingly, it is the primary object of the present invention to provide a heater structure, and more particularly to a heater structure whose heating core is specially designed at a place locating the temperature switch so as thereby to prevent the heating core from frequently stopping/starting, such that a possible high temperature at the heating core can be avoided.

In the present invention, the heater structure includes heating core, at least one heating tube and a temperature switch. The heating core has an inlet, an outlet and an inner space to be integrally formed in space as a channel. The heating core has a first lateral wall with a first thickness. The first lateral wall further has an installation portion with a second thickness, in which the first thickness and the second thickness are not identical. The heating tube provides the thermal energy to the contacted heating core. The temperature switch is to detect the temperature and contacts the installation portion.

All these objects are achieved by the heater structure described below.

### BRIEF DESCRIPTION OF THE DRAWINGS

The present invention will now be specified with reference to its preferred embodiment illustrated in the drawings, in which:

FIG. 1 is a schematic top view of an embodiment of the heater structure in accordance with the present invention;

FIG. 2 is a cross-sectional view of FIG. 1 along line A-A;

FIG. 3 is a cross-sectional view of another embodiment of the heater structure in accordance with the present invention;

FIG. 4 is a cross-sectional view of a further embodiment of the heater structure in accordance with the present invention;

FIG. 5 is a cross-sectional view of one more embodiment of the heater structure in accordance with the present invention;

FIG. 6 is a further cross-sectional view of FIG. 5 along line B-B;

FIG. 7A is a schematic top view of an embodiment of the non-absolute-island-type protrusive block in accordance with the present invention;

FIG. 7B is a cross-sectional view of FIG. 7A along line C-C;

FIG. 7C is a cross-sectional view of FIG. 7A along line D-D;

FIG. 8A is a schematic top view of another embodiment of the non-absolute-island-type protrusive block in accordance with the present invention; and

FIG. 8B is a cross-sectional view of FIG. 8A along line E-E.

### DESCRIPTION OF THE PREFERRED EMBODIMENT

The invention disclosed herein is directed to a heater structure. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

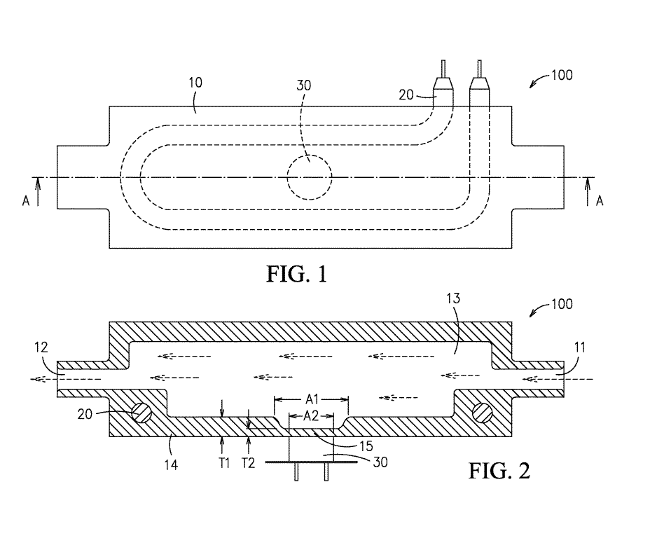

Referring now to the embodiment of the heater structure shown in FIG. 1 and FIG. 2, the heater 100 includes a heating core 10, a heating tube 20 and a temperature switch 30. The heating core 10, the heating tube 20 and the temperature switch 30 are all electrically coupled to and thus controlled by a control unit (not shown in the figures). For example, the control unit can base on the detected temperature of the temperature switch 30 to control ON/OFF of the heating core 10 and the heating tube 20. In the present invention, the heating core 10 can be made of a heat-conductive material.

The heating core 10 has an inlet 11, an outlet 12 and an inner space 13. As shown, the inlet 11, the outlet 12 and the inner space 13 are integrally to form a common channel. A fluid-type medium is introduced from the inlet 11 into the inner space 13, and then flowed out of the inner space 13 via the outlet 12. In this embodiment, the medium pathway formed between the inlet 11 and the outlet 12 is a homogeneous pathway. However, in some other embodiments, the medium pathway can be any arbitrary pathway connecting the inlet and the outlet.

The heating core 10 has a first lateral wall 14, and the first lateral wall 14 further has a first thickness T1. The first lateral wall 14 is constructed with an installation portion 15. In this embodiment, the installation portion 15 is a thin-shell structure having a thickness equal to a second thickness T2, in which the second thickness T2 is smaller than the first thickness T1. A projection area of the installation portion 15 is located within the medium pathway.

The heating tube 20 is to provide thermal energy. In this embodiment, the heating tube 20 is extended from outsides of the heating core 10 to insides of the heating core 10, and is contacted with the heating core 10. Thereby, the thermal energy of the heating tube 20 can be transmitted to both the heating core 10 and the medium inside the inner space 13.

The temperature switch 30 is contacted with the installation portion 15. In this embodiment, the temperature switch 30 is located outside the heating core 10 for detecting the temperature of the installation portion 15. In addition, the projection area A1 of the installation portion 15 covers the contact area A2 of the temperature switch 30 and the installation portion 15.

It is worthy to note that, when the heating tube 20 and the heating core 10 are tightly engaged, then a well heat conduction in between can be ensured. Also, the installation position of the heating tube 20 shall enable direct detection at the temperature of the heating core 10 temperature. In addition, the heating tube 20 can be helical or in any relevant shape.

As shown in FIG. 2 by the arrowed lines, the medium to be heated enters the inner space 13 via the inlet 11 and be heated by the thermal energy generated by the heating tube 20. The heated medium is then flowed out of the heating core 10 via the outlet 12. Since the heating core 10 is locally a thin-shell structure at the installation portion 15 for mounting the temperature switch 30, the heat transmitted from the heating tube 20 to the temperature switch 30 can be substantially reduced, and thus an unexpected high temperature detected by the temperature switch 30 can be avoided.

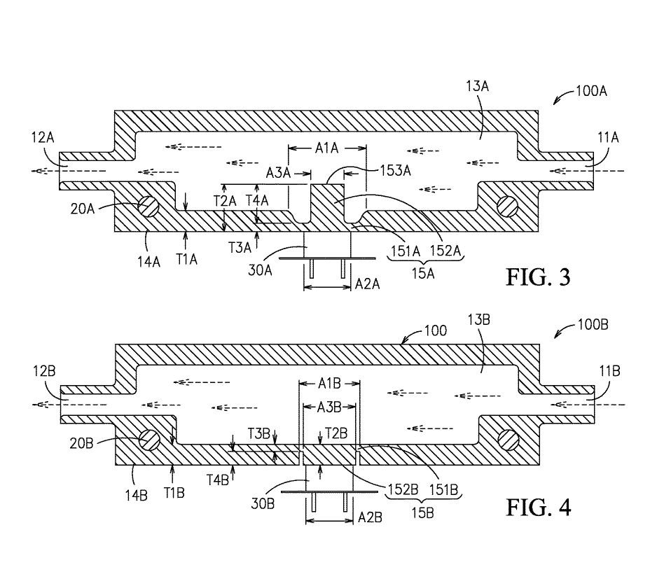

Referring now to the embodiment shown in FIG. 3, the heater 100A includes a heating core 10A, a heating tube 20A and a temperature switch 30A. The heating core 10A has an inlet 11A, an outlet 12A and an inner space 13A, in which the inlet 11A, the outlet 12A and the inner space 13A are integrated in space to for a channel. This embodiment is obtained by modifying the foregoing embodiment of FIG. 2, and thus details for common components and structures would be omitted herein.

The heating core 10A has a first lateral wall 14A with a first thickness T1A. The first lateral wall 14A further has an installation portion 15A with a second thickness T2A. In this embodiment, the installation portion 15A is consisted of a thin-shell structure 151A and a protrusive block 152A. The thin-shell structure 151A has a third thickness T3A, and the protrusive block 152A has a fourth thickness T4A. The sum of the third thickness T3A and the fourth thickness T4A is equal to the second thickness T2A, while the second thickness T2A is larger than the first thickness T1A. The protrusive block 152A has a top end 153A at a position corresponding to the first lateral wall 14A, and the top end 153A is located in the inner space 13A.

The temperature switch 30A is located outside the heating core 10A. The projection area A1A of the installation portion 15A can cover the contact area A2A of the temperature switch 30A and installation portion 15A. Also, the projection area A1A of the installation portion 15A can cover the projection area A3A of the protrusive block 152A.

As shown in FIG. 3 by the arrowed lines, the medium to be heated enters the inner space 13A via the inlet 11A and be heated by the thermal energy generated by the heating tube 20A. The heated medium is then flowed out of the heating core 10A via the outlet 12A. Since the heating core 10 is locally a thin-shell structure 151A at the installation portion 15A for mounting the temperature switch 30A and the protrusive block 152A, the heat transmitted from the heating tube 20A to the temperature switch 30A can be substantially reduced, the medium can absorb the thermal energy of the protrusive block 152A while the medium passes the protrusive block 152A, and thus an unexpected high temperature detected by the temperature switch 30A can be avoided.

Referring now to the embodiment shown in FIG. 4, the heater 100B includes a heating core 10B, a heating tube 20B and a temperature switch 30B. The heating core 10B further has an inlet 11B, an outlet 12B and an inner space 13B. The inlet 11B, the outlet 12B and the inner space 13B are integrated in space to form a channel.

The heating core 10B has a first lateral wall 14B with a first thickness T1B. The first lateral wall 14B further includes an installation portion 15B with a second thickness T2B. In this embodiment, the installation portion 15B is consisted of a thin-shell structure 151B and a protrusive block 152B. The thin-shell structure 151B has a third thickness T3B, and the protrusive block 152B has a fourth thickness T4B. In this embodiment, a sum of the third thickness T3B and the fourth thickness T4B is equal to the second thickness T2B, and the second thickness T2B is equal to the first thickness T1B. However, in some other embodiments, the sum of the third thickness T3B and the fourth thickness T4B might not be equal to the second thickness T2B. The requirement needs that, if the temperature switch 30B can be installed, the second thickness T2B can be greater than the sum of the third thickness T3B and the fourth thickness T4B. Similarly, the second thickness T2B can be smaller than the sum of the third thickness T3B and the fourth thickness T4B. Namely, it is not necessary that the top end of the protrusive block 152B shall be flush with the outer wall of the first lateral wall 14B. The fourth thickness T4B might be the bigger one or the smaller one. The protrusive block 152B, with respect to the first lateral wall 14B, has the top end 153B to be located outside the heating core 10B. The temperature switch 30B can thus be located at the top end 153B, the projection area A1B of the installation portion 15B can cover the contact area A2B of the temperature switch 30B and the installation portion 15B (i.e., the protrusive block 152B), and the projection area A1B of the installation portion 15B can cover the projection area A3B of the protrusive block 152B.

Referred to the path pointed by the arrowed lines of FIG. 4, the medium to be heated is introduced into the inner space 13B from the inlet 11B and then to be heated by the thermal energy generated by the heating tube 20B. The heated medium is then to leave the heating core 10B via the outlet 12B. Since the installation portion 15B of the heating core 10B for mounting the temperature switch 30B is a combination of a thin-shell structure 151B and a protrusive block 152B, the heat transmitted from the heating tube 20B to the temperature switch 30B through the thin-shell structure 151B can be reduced. The heat of the protrusive block 152B can be dissipated out of the heating core 10B, so that the detected temperature by the temperature switch 30B can be avoided not to overflow.

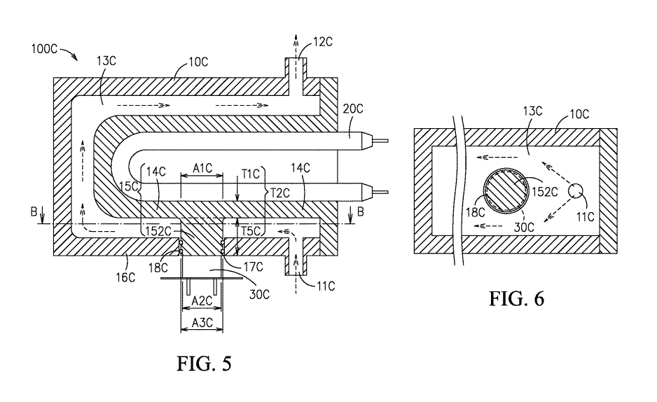

Referring now to the embodiment shown in FIG. 5 and FIG. 6, the heater 100C includes a heating core 10C, a heating tube 20C and a temperature switch 30C. The heating core 10C has an inlet 11C, an outlet 12C and an inner space 13C, in which the inlet 11C, the outlet 12C and the inner space 13C are integrated in space to form a channel. In this embodiment, the heating core 10C and the heating tube 20C are both U-shaped, and the heating tube 20C is located outside of the heating core 10C. Namely, the heat of the heating tube 20C can be directly conducted to the heating core 10C, and then transmitted to the medium inside the inner space 13C.

The heating core 10C has a first lateral wall 14C with a first thickness T1C. The first lateral wall 14C further has an installation portion 15C with a second thickness T2C. In this embodiment, the installation portion 15C is consisted of the first lateral wall 14C and a protrusive block 152C with a fifth thickness T5C. Hence, a sum of the first thickness T1C and the fifth thickness T5C is equal to the second thickness T2C, and the second thickness T2C is greater than the first thickness T1C. With respect to the first lateral wall 14C, the heating core 10C has a second lateral wall 16C having a hole 17C. A top end 153C of the protrusive block 152C protrudes into the hole 17C. Particularly, a sealing member 18C is located between the protrusive block 152C and the hole 17C. The heat conductivity of the sealing member 18C is lower than that of the heating core 10C. The temperature switch 30C is located on the top end 153C. In this embodiment, the protrusive block 152C is protruded from the first lateral wall 14C and has a third thickness T3C. Namely, the second thickness T2C of the installation portion 15C in this embodiment is equal to the first thickness T1C of the first lateral wall 14C. Hence, a sum of the second thickness T2C and the third thickness T3C is not less than the first thickness T1C. The projection area A1C of the installation portion 15C is to cover the contact area A2C of the temperature switch 30C and the installation portion 15C (i.e., the protrusive block 152C), and the projection area A1C of the installation portion 15C is to cover the projection area A3C of the protrusive block 152C. In particular, in this embodiment, A1C=A3C. Further, in this embodiment, resembled to the embodiment of FIG. 3 and FIG. 4, the installation portion herein can be consisted of the thin-shell structure and the protrusive block. Similarly, the thin-shell structure and the protrusive block to form the installation portion in FIG. 3 and FIG. 4 can be replaced by the first lateral wall 14C protruded from the protrusive block 152C in this embodiment.

Referred to the path pointed by the arrowed lines of FIG. 5, the medium to be heated is introduced into the inner space 13C from the inlet 11C and then to be heated by the thermal energy generated by the heating tube 20C. The heated medium is then to leave the heating core 10C via the outlet 12C. Since the medium can absorb the heat generated by the protrusive block 152C while it passes by, and thus the detected temperature by the temperature switch 30C can be avoided not to be too high.

In addition, in the embodiments of FIG. 3, FIG. 4 and FIG. 5, the corresponding cross sections for the protrusive blocks 152A, 152B and 152C can be regularly shaped. For example, the protrusive block 152A is a cylinder, and so its cross section is round. Also, since the protrusive block 152A is a square pillar, and so the cross section is a square. However, the cross sections of the protrusive blocks 152A, 152B and 152C can be irregularly shaped, such as a non-absolute-island type.

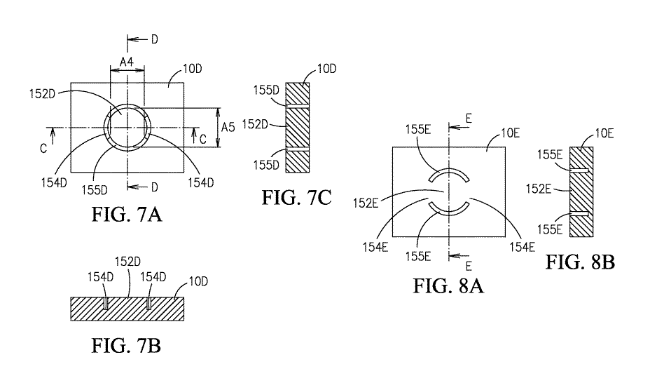

Referring now to the embodiment shown in FIG. 7A through FIG. 7C, the heating core 10D contains only the protrusive block 152D shaped in accordance with a non-absolute-island type. The protrusive block 152D and the heating core 10D are presented to have communicative portions 154D and non-communicative portions 155D. The protrusive block 152D connects the heating core 10D through the communicative portions 154D, and the non-communicative portion 155D is simply a blind structure. The least cross section of the communicative portion 154D (A4 in FIG. 7A) is smaller or equal to the circular area of the non-communicative portion 155D (A5 in FIG. 7A). Namely, if the protrusive block 152D is a cylinder, the aforesaid circular area is the lateral side surface of the cylinder. On the other hand, if the protrusive block 152D is irregularly shaped, the circular area is the lateral surface area of a larger inner-cut circle of the protrusive block 152D, viewed from top. Referring now to FIG. 8A and FIG. 8B, the heating core 10E is shown to have only a protrusive block 152E, which is also a non-absolute-island-type block. The protrusive block 152E and the heating core 10E include also communicative portions 154E and non-communicative portions 155E. Via the communicative portions 154E, the protrusive block 152E can connect with the heating core 10E. Again, the non-communicative portions 155E are blind structures.

In summary, the heater structure of the present invention includes special designs for the at the temperature switch with respect to the heating core. A common feature of the aforesaid embodiments is that a different thickness for the installation portion to mount the temperature switch is provided, with respect to the thickness of the heating core; such as the thin-shell structure of FIG. 2, or the combination of the thin-shell structure and the protrusive block in FIG. 3 and FIG. 4, and the protrusive block in FIG. 5. the purpose for such a design is to reduce the temperature that is possible accumulated around the temperature switch, such that the frequent ON/OFF operations upon the heating core can be avoided, and thus the temperature of the heating core can be prevented from overflowing.

While the present invention has been particularly shown and described with reference to a preferred embodiment, it will be understood by those skilled in the art that various changes in form and detail may be without departing from the spirit and scope of the present invention.

What is claimed is:

1. A heater structure, comprising:
a heating core, having an inlet, an outlet and an inner space, wherein the inlet, the outlet and the inner space are integrated in space to form a channel, a medium pathway be formed between the inlet and the outlet, the heating core further having a first lateral wall with a first thickness, the first lateral wall further having an installation portion with a second thickness different to the first thickness;
at least one heating tube for providing a thermal energy, the at least one heating tube contacting the heating core; and
a temperature switch for detecting a temperature, mounted at the installation portion.

2. The heater structure of claim 1, wherein the installation portion is a thin-shell structure with a thickness equal to the second thickness, wherein the second thickness is smaller than the first thickness.

3. The heater structure of claim 1, wherein the installation portion is consisted of a thin-shell structure and a protrusive block, the protrusive block having a top end at a position corresponding to the first lateral wall, the thin-shell structure having a third thickness, the protrusive block having a fourth thickness, a sum of the third thickness and the fourth thickness being equal to the second thickness.

4. The heater structure of claim 3, wherein the top end is located inside the inner space.

5. The heater structure of claim 2, wherein the temperature switch is located outside the heating core.

6. The heater structure of claim 3, wherein the top end is located outside the heating core, and the temperature switch is mounted on the top end.

7. The heater structure of claim 3, wherein a sum of the third thickness and the fourth thickness is not equal to the second thickness.

8. The heater structure of claim 1, wherein the installation portion is consisted of the first lateral wall and a protrusive block, the protrusive block with a fifth thickness having a top end with respect to the first lateral wall, a sum of the first thickness and the fifth thickness being equal to the second thickness, the heating core having a a second lateral wall with respect to the first lateral wall, the second lateral wall having a hole, the top end protruding into the hole, the temperature switch being mounted on the top end, the protrusive block and the hole having a sealing member in between.

9. The heater structure of claim 1, wherein a projection area of the installation portion covers a contact area of the temperature switch and the installation portion.

10. The heater structure of claim 3, wherein a projection area of the installation portion covers another projection area of the protrusive block.

11. The heater structure of claim 1, wherein the heating tube is helical.

12. The heater structure of claim 1, wherein the medium pathway is a channel able to flow a fluid.

13. The heater structure of claim 2, wherein a projection area of the installation portion is in the medium pathway.

14. The heater structure of claim 4, wherein the protrusive block is irregularly shaped to have a cross section of a non-absolute-island type, the protrusive block and the heating core having communicative portions and non-communicative portions, a least cross section of the communicative portions being no more larger than a circular area of the non-communicative portions.

15. The heater structure of claim 4, wherein the temperature switch is located outside the heating core.

16. The heater structure of claim 8, wherein a projection area of the installation portion covers another projection area of the protrusive block.

17. The heater structure of claim 6, wherein a projection area of the installation portion is in the medium pathway.

18. The heater structure of claim 6, wherein the protrusive block is irregularly shaped to have a cross section of a non-absolute-island type, the protrusive block and the heating core having communicative portions and non-communicative portions, a least cross section of the communicative portions being no more larger than a circular area of the non-communicative portions.
